(19) United States
(12) Patent Application Publication
(10) Pub. No.: US 2008/0114941 A1
(43) Pub. Date: May 15, 2008

(54) Code generation method and compiler

(76) Inventor: Hiroyasu Nishiyama, Kawasaki (JP)

Correspondence Address: MCDERMOTT WILL & EMERY LLP, 600 13TH STREET, N.W., WASHINGTON, DC, 20005-3096, US

(21) Appl. No.: 11/976,084

(22) Filed: Oct. 19, 2007

(30) Foreign Application Priority Data
Oct. 19, 2006 (JP) 2006-284638

(51) Int. Cl. G06F 12/00

(52) U.S. Cl. 711/129

(57) ABSTRACT

For a program that runs on a microprocessor having a cache memory and an on-chip memory embedded therein with a capability of specifying and assigning embedded memory capacities, memory capacities to be allocated to the cache memory and the on-chip memory are determined according to memory sizes required for a set of referent data in the program, and a code is generated based on the memory capacities determined. The program may be divided by extracting at least one phase each comprised of a loop in the program and a set of referent data referred to in each phase, so that the memory capacities are determined according to the memory sizes required for the set of referent data divided.

### CROSS-REFERENCE TO RELATED APPLICATION(S)

This application claims the foreign priority benefit under Title 35, United States Code, § 119 (a)-(d), of Japanese Patent Application No. 2006-284638, filed on Oct. 19, 2006 in the Japan Patent Office, the disclosure of which is herein incorporated by reference in its entirety.

### BACKGROUND OF THE INVENTION

1. Field of the Invention

The present invention relates to a code generation method and a compiler for a program running on a computer which comprises embedded memories such as an on-chip memory and a cache memory and has a function to change their memory capacities to be assigned to the program so that data in the program can be placed in an efficient manner.

2. Description of the Related Art

A typical computer system comprises a microprocessor for computing and a main memory for storing data. In general, the access speed of the main memory is relatively low (referencing performance is low) compared with the operation performance of the microprocessor. Hence, there occurs unbalance in processing speed between the microprocessor and the main memory. Accordingly, many of the microprocessors comprise a high speed, small capacity embedded memory called cache memory. A copy of data on the main memory is placed on the cache memory, and as long as data exist on the cache memory, high speed data referencing can be performed. This is achieved by the following mechanism.

That is, when referring to data on the main memory, the microprocessor checks whether a copy of the data exists on the cache memory. If a copy of the data exists, the data on the cache memory are referred to, and thus high speed data referencing is achieved. If no copy of the data exists on the cache memory, the data are read out from the main memory, and a copy of the data is placed on the cache memory.

The cache memory is managed in regions of a fixed size called cache lines or cache blocks. In order to determine whether data exist on the cache, the cache memory comprises a mechanism called a tag in addition to the regions for storing data. The tag is a mechanism for storing information to identify the source address of data present on the cache and is used to confirm the presence of data in the cache and to write back the data to the main memory.

As mentioned above, the cache memory replaces data by means of hardware, and thus data that are frequently referenced by the program would not always exist on the cache, in which instances, the execution performance of the program would become low. Such a problem occurs because data on the cache are replaced by, for example, data for which the number of reference times is no greater than one. Further, because the program cannot realize whether certain data exist on the cache, it is difficult to estimate the execution time of the program.

In order to deal with such a problem, a technique has been proposed which provides a high speed embedded memory region called on-chip memory on memory space and performs data transfer between the region and the main memory according to a program (refer to, for example, “SuperH, SH-4 Core Architecture Manual”, SuperH, Inc., 2003). With the cache memory, data are copied implicitly by hardware. On the other hand, with the on-chip memory, which needs explicit copying, it can be ensured that data once copied on the on-chip memory by software can be referenced at high speed. Further, the on-chip memory does not need a tag to associate data with a main memory address. Thus, higher reference speed and lower power consumption can be expected.

As to the technique of placing data onto an on-chip memory, a technique has been proposed where whether to place onto an on-chip memory is specified for individual data defined in the source code of a program by means of an extended specification for a standard programming language specification (refer to, for example, “ISO/IEC JTC1 SC22 WG14, Extensions for the programming language C to support embedded processors”, ISO/IEC, 2003).

FIGS. 3A and 3B are source codes of example programs for specifying data placement onto an on-chip memory. FIG. 3A shows an original program before data placement onto an on-chip memory is applied, and FIG. 3B shows a modified program to provide an intermediate buffer on the on-chip memory and to cause block transfer to be performed between the intermediate buffer and a main memory. Herein, N is a multiple of ten for simplicity.

In the original program of FIG. 3A, at (1), references to the elements of data a, b occur. Because these references occur only once, placing the data a, b onto a cache is wasteful except the efficient transfer of the data by block transfer. Further, the negative influence occurs that if data necessary in the subsequent execution of the program exist on the cache, the data are expelled.

Accordingly, an intermediate buffer is provided on the on-chip memory to have block transfer performed between the intermediate buffer and the main memory. A source program modified in this way is shown in FIG. 3B, where “_X” indicates an instruction to place its declared data on the on-chip memory, and “copy” means to perform the block transfer of a specified number of elements by its third argument from the address specified by its second argument to the area specified by its first argument. Assume that in the block transfer, registering data on a cache is not performed.

In the modified program of FIG. 3B, at (2), a temporary area for data transfer is secured in the on-chip memory; at (3), the data are transferred from the main memory to the on-chip memory; at (4), an operation is performed on the data on the on-chip memory; and at (5), the data are written back from the on-chip memory to the main memory. Since in this series of processes, registering data on the cache memory does not occur, the execution of the program can be made more efficient.

The technique of placing data onto an on-chip memory with performing such modification of the source program requires modification of the source program according to a non-standard programming language specification and programming with being conscious of the available on-chip memory capacity. Hence, difficulty in creating programs increases, and the portability of programs using an on-chip memory to other systems decreases. Accordingly, for computer systems comprising an on-chip memory and a main memory, a technique has been disclosed where on which of the on-chip memory and the main memory data appearing in the program are to be placed is determined from the results of analyzing the source program or operation information, called profile information, which was obtained when the program was preliminarily executed (refer to, for example, O. Avissar et al. “An Optimal Memory Allocation Scheme for Scratch-Pad-Based Embedded Systems”, ACM Transactions on Embedded Computing Systems, Vol. 1, No. 1, 2002).

Because the cache memory and the on-chip memory are not incompatible, some microprocessors comprise both a cache memory and an on-chip memory. In such processors, the maximum volumes of data storable in the cache memory and the on-chip memory are usually fixed, while the capacities required of the cache memory and the on-chip memory differ depending on the application of the processor and the program.

Accordingly, a technique has been proposed where an embedded memory region is shared by the cache memory and the on-chip memory to store data and where the size to be assigned to each memory is selectable on a per program or system basis (refer to, for example, “SuperH, SH-4 Core Architecture Manual”, SuperH, Inc., 2003).

### SUMMARY OF THE INVENTION

As described above, a cache memory and an on-chip memory are different in effective application. Data effective to be placed on the on-chip memory and data effective to be placed on the cache memory often differ for each phase of the program.

Accordingly, for a processor comprising both a cache memory and an on-chip memory and which can select individual capacities to be assigned, the capacities assigned to the cache memory and the on-chip memory need to be adjusted to optimum values for each phase of the program in order to have a program operate efficiently. However, with the conventional technique which modifies programs, there is the problem of the loss of program portability.

Furthermore, in the conventional technique where a compiler automatically places data onto an on-chip memory, code is generated assuming the on-chip memory being of fixed size. Thus, optimum assignment of the cache memory and the on-chip memory to the embedded memory region for each phase of a program cannot be achieved. Further, there is the problem that if the embedded memory region has unused part for a phase of the program, power is wastefully consumed.

The present invention has been made in an attempt to solve the above problems, and it is an aspect of the present invention to provide a code generation method and a compiler that can place data of a program efficiently for a computer comprising embedded memories such as on-chip memory, cache memory, and the like which have a function to change their memory capacities as assigned by the program.

For a program that runs on a microprocessor having a cache memory and an on-chip memory embedded therein with a capability of specifying and assigning embedded memory capacities, according to one aspect of the present invention, memory capacities to be allocated to the cache memory and the on-chip memory are determined according to memory sizes required for a set of referent data in the program (memory determining process), and a code is generated based upon the memory capacities determined (code generation process). The program may be divided by extracting at least one phase each comprised of a loop in the program and a set of referent data referred to in each phase, so that the memory capacities are determined according to the memory sizes required for the set of referent data divided.

In one embodiment, a code generation method and a compiler divides a program into phases each comprised of a loop, for example, at a point of low data reference frequency determined by control flow analysis for analyzing operation of the program, determines memory capacities to be allocated to the cache memory and the on-chip memory for each phase, and generates a code having inserted therein commands or instructions to dynamically change the allocation to these memories during the execution of the program.

According to the illustrative embodiments of the present invention, a code is provided which allows the program to operate efficiently for a microprocessor, that comprises both a cache memory and an on-chip memory and can select individual memory capacities to be assigned.

### BRIEF DESCRIPTION OF THE DRAWINGS

Various aspects, other advantages and further features of the present invention will become more apparent by describing in detail illustrative, non-limiting embodiments thereof with reference to the accompanying drawings, in which:

FIG. 1 is a configuration diagram showing an example of a computer system that the present invention can be applied to;

FIG. 2 illustrates an example of optimization by a language processor according to the present invention;

FIGS. 3A and 3B are source codes of example programs for specifying data placement onto an on-chip memory;

FIG. 4 is a flow chart showing a phase division process according to embodiment 1;

FIGS. 5A and 5B illustrate examples of a source code of a program subject to the phase division process;

FIG. 6 is a flow chart showing a data mapping process according to embodiment 1;

FIG. 7 illustrates evaluated values for combinations in the data mapping process;

FIG. 8 is a flow chart showing a code generation process according to embodiment 1;

FIG. 9 is a flow chart showing an assignment changing code generation process;

FIG. 10 illustrates an example of data assignment for each phase;

FIG. 11 illustrates an example of generated codes;

FIG. 12 is a flow chart showing the phase division process for directive statements according to embodiment 2;

FIG. 13 illustrates an example where directives to specify the capacities to be assigned to a cache memory and an on-chip memory in an embedded memory region for the respective phases are inserted in a source program;

FIG. 14 is a flow chart showing a combination set determining process for data of variable data size according to embodiment 4; and

FIG. 15 illustrates evaluated values for combinations for data of variable data size.

### DETAILED DESCRIPTION OF THE EXEMPLARY EMBODIMENTS

Embodiments according to the present invention will be described below with reference to the drawings.

### Embodiment 1

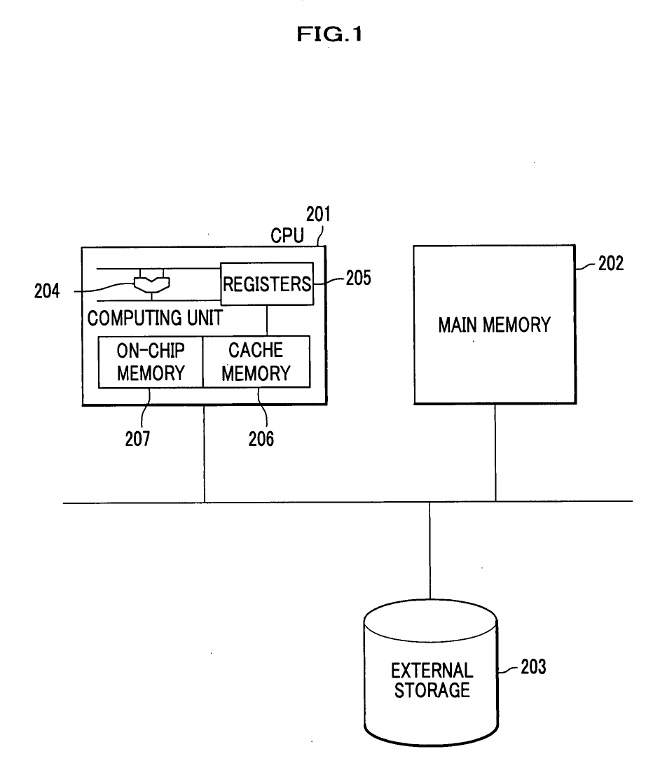

FIG. 1 is a configuration diagram showing an example of a computer system to which the present invention can be applied. The computer system comprises a processor (CPU) 201, a main memory 202, and an external storage 203, and the CPU 201 comprises a computing unit 204, registers 205, a cache memory 206, and an on-chip memory 207. A language processor and a source program are stored in the external storage 203 and are read by the CPU 201 to compile the source program. A program generated by the compiling is held in the main memory 202 or stored in the external storage 203 and is read and executed by the CPU 201.

When the CPU 201 references memories, the address of the object to be referenced is examined, and if the address is within the on-chip memory region, data at the address on the on-chip memory 207 are referenced. If the address is not within the on-chip memory region, it is checked whether a copy of data at the address to be referenced exists on the cache memory 206, and if a copy exists, the copied data are referenced. If a copy does not exist, data at the address on the main memory 202 are referenced, and a copy of the cache block containing the data is placed on the cache memory 206. Referencing the on-chip memory 207 and the cache memory 206 is at higher speed than referencing the main memory 202. Thus, if data to be referenced exist on the on-chip memory 207 or the cache memory 206, wait time that occurs due to memory reference can be reduced. In computer systems to which the present invention can be applied, the capacities assigned to the cache memory 206 and the on-chip memory 207 can be changed by software.

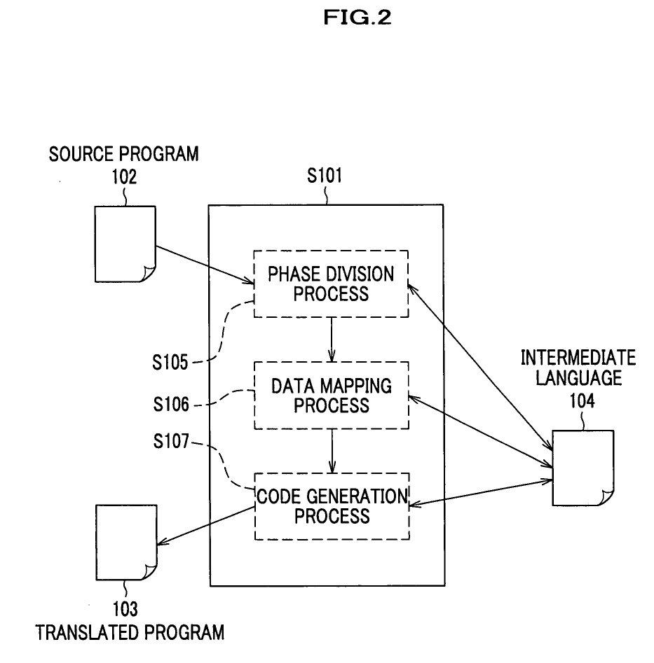

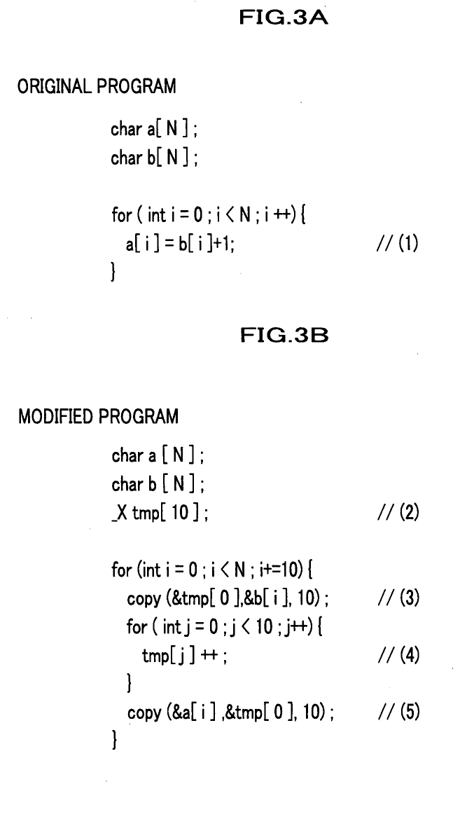

FIG. 2 illustrates an example of optimization by the language processor according to the present invention. In optimization S101, a source program 102 is inputted, and after optimization is applied, a translated program 103 is generated. The translated program may be generated in file format and stored in the external storage 203 of FIG. 1 as with a usual compiler, or as a Just-In-Time (JIT) compiler, the translated program may be generated and placed in the main memory 202 during the execution of the program and immediately executed. The optimization S101 generates and references an intermediate language 104 during the application of optimization. The optimization S101 comprises a phase division process S105, a data mapping process S106, and a code generation process S107.

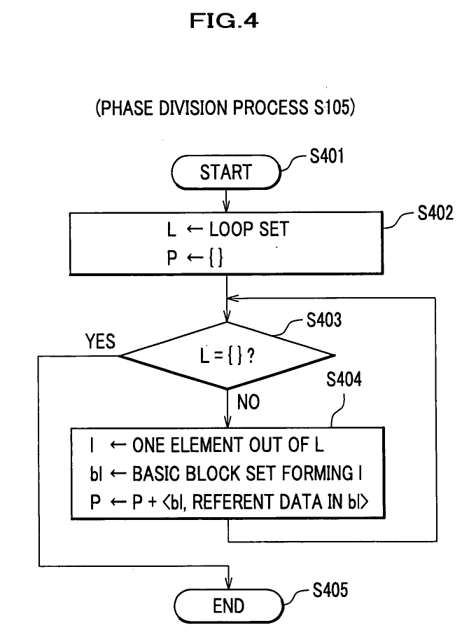

FIG. 4 is a flow chart showing the phase division process of embodiment 1. The phase division process of FIG. 4 analyzes the control flow of the program and forms phases on the basis of a phase per loop in the program. Because generally changes in the assignment of the embedded memory region take overhead, it is better to change at points of low data reference frequency in the program. By forming phases on the basis of a phase per loop in the program, the program is divided at points of low data reference frequency. Hence, changes in the assignment can be expected to be performed with low overhead. As to the control flow analysis and the method of recognizing loops, a standard program analysis technique, as described in, e.g., A. V. Aho et al. “Compilers, Principles, Techniques, and Tools”, Addison-Wesley, 1986, can be used.

As shown in FIG. 4, the phase division process S105 starts at step S401; at step S402 a set of the loops in the program is set as a variable L; and a variable P for storing phase information is initialized to an empty set. Then, at step S403 it is determined whether the variable L is an empty set. If being an empty set (YES at step S403), because no loop to be processed exists, control is passed to step S405, which ends the process. If at step S403 the variable L is not an empty set (NO at step S403), control is passed to step S404, which takes one element out of the variable L and stores it into a variable 1. Then, a set of the basic blocks forming the variable 1 is obtained and stored into a variable bl, and the basic block set bl forming the variable 1 and a set of the data referenced in the bl are added in a pair to the variable P. By this process, for each of the loops as phases in the program, the basic blocks forming the phase and a set of the data referenced therein are obtained. In the phase division process, optimization such as extracting program parts to be executed frequently by use of profile information or the like may be applied.

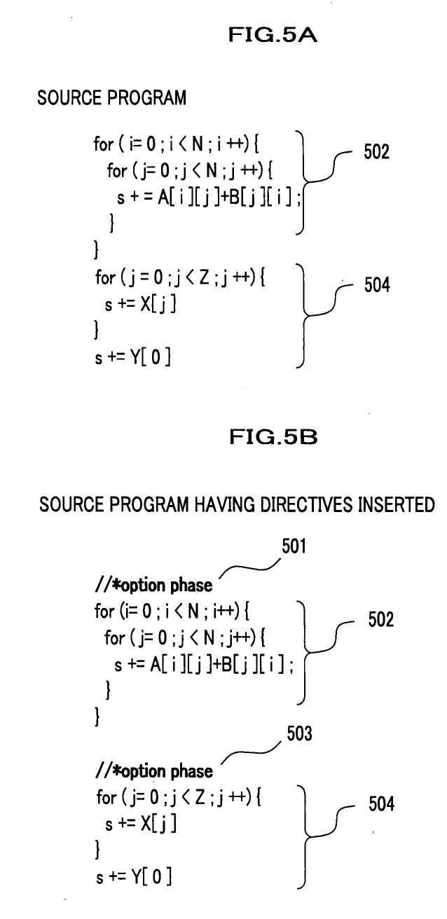

FIGS. 5A and 5B illustrate example source programs subject to the phase division process. FIG. 5A shows an example source program to be automatically divided, and FIG. 5B shows an example source program having directives inserted therein. Such directives are commands (instructions) to a compiler that are embedded in programs. Herein, //*option indicates a command (instruction) to the compiler, and the directive is an instruction from a user.

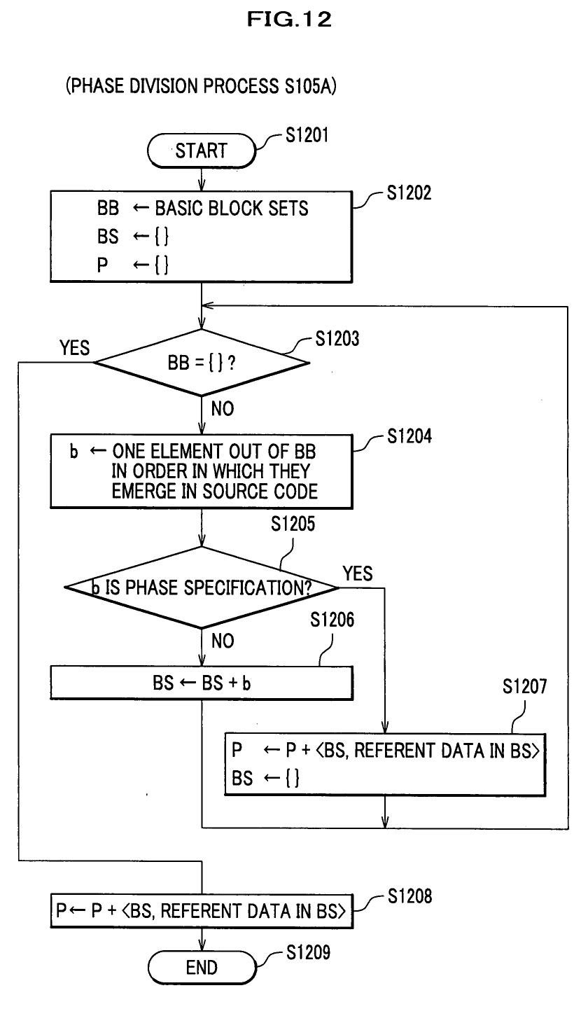

When the algorithm shown in FIG. 4 is applied to the source program of FIG. 5A, loops 502, 504 are stored into the variable L (a loop set) at step S402. As a result of applying step S404 to these loops, pairs of the basic blocks forming the loop and the data referenced therein for the loops 502, 504 are finally stored in the variable P. The source program of FIG. 5B is obtained by inserting directives into the program of FIG. 5A for phase specification described later with reference to FIG. 12.

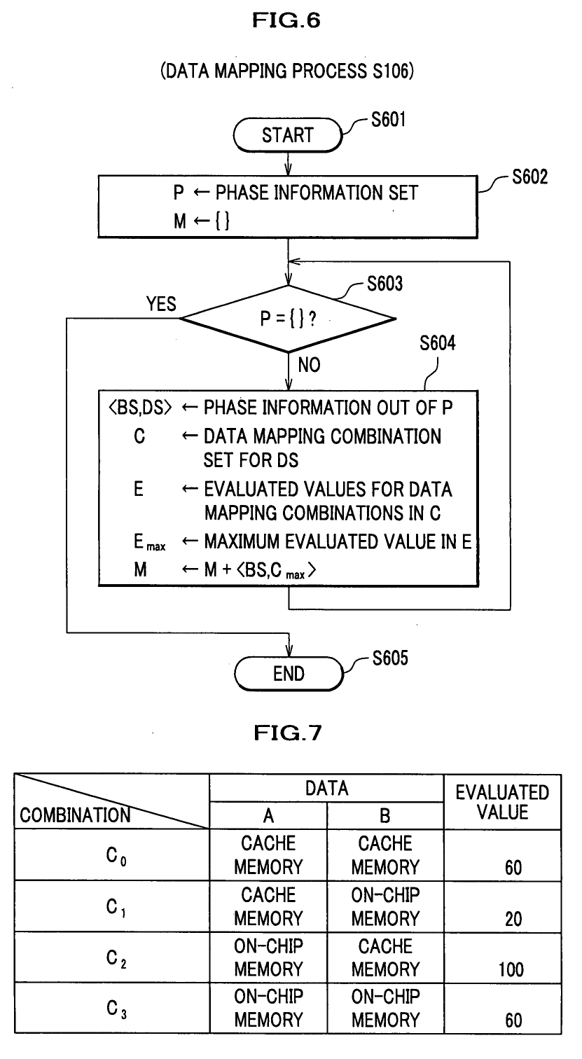

FIG. 6 is a flow chart showing the data mapping process according to embodiment 1. As shown in FIG. 6, the data mapping process S106 starts at step S601. At step S602 a set of phase information is stored in the variable P, and a variable M for storing a set of data mapping results is initialized to an empty set. Then, at step S603 it is determined whether the variable P, the phase information set, is an empty set. If being an empty set (YES at step S603), because no element to be processed exists, control is passed to step S605, which ends the process. If at step S603 the variable P is not an empty set (NO at step S603), control is passed to step S604, which takes one element, i.e., a pair of a basic block set and a referenced data set out of the phase information set and stores them respectively into variables BS and DS.

Then, a set of data mapping combinations for the set of referenced data in the variable DS are obtained and stored into a variable C. The data mapping combinations are obtained as combinations of embedded memory regions on which the respective data are locatable. Then, an evaluated value is obtained for each of the data mapping combinations in the variable C. This evaluated value indicates, for each data placement, an expected value of performance in terms of items to be optimized such as program execution time, memory usage, and power consumption and is obtained from the predicted number of execution times of each of the basic blocks forming the program, the inferred operational results of the processor, and the like. The obtained evaluated values are stored in a variable E, and the maximum of the evaluated values is selected as a maximum evaluated value Emax. The basic block set forming the phase and the data mapping combination corresponding to the Emax, which is set as a variable Cmax, are added to the variable M, which contains a set of data mapping results. Thereafter, control is passed to step S603, which moves on to the next phase information.

FIG. 7 illustrates the evaluated values for the combinations in the data mapping process, and shows an example where step S604 in the data mapping process of FIG. 6 is applied to the doubly nested loop 502 of FIG. 5A. In the loop 502 of FIG. 5A, two data references to data A and B exist. Considering placing each of these data on either the cache memory or the on-chip memory, there are combinations C₀ to C₃ of data placement shown in FIG. 7. Suppose, as an example, that the expected value of performance improvement when placed on the cache memory is 10 and 50 respectively for data A and data B, and the expected value when placed on the on-chip memory is 50 and 10 respectively for data A and data B. Assuming that the evaluated value for each data placement is given as the sum of the expected values for them, results as shown in the evaluation column of FIG. 7 are obtained. From these results, the data placement of combination C₂, where data A are placed on the on-chip memory and data B are placed on the cache memory, is expected to produce the best result.

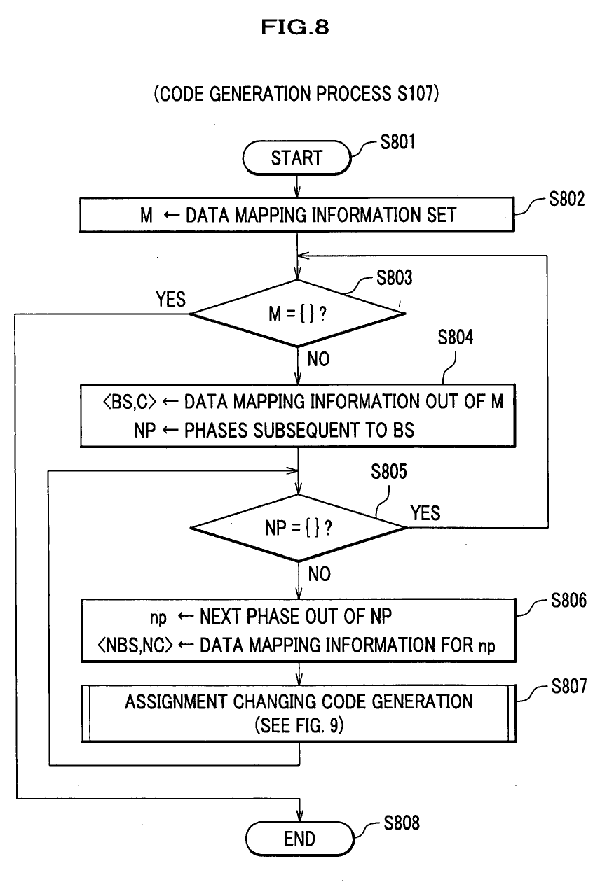

FIG. 8 is a flow chart showing the code generation process. As shown in FIG. 8, a code generation process S107 starts at step S801. At step S802 the data mapping information set obtained in the data mapping process is stored in the variable M. Then, at step S803 it is determined whether the variable M, the data mapping information set, is an empty set. If being an empty set (YES at step S803), because no data mapping information to be processed exists, control is passed to step S808, which ends the process. If at step S803 the variable M is not an empty set (NO at step S803), control is passed to step S804, which takes data mapping information, i.e., one pair of a basic block set and the data mapping combination for referenced data out of the variable M. Then, a set of the phases subsequent to the basic block set of the variable BS without passing other phases is obtained and stored into a variable NP.

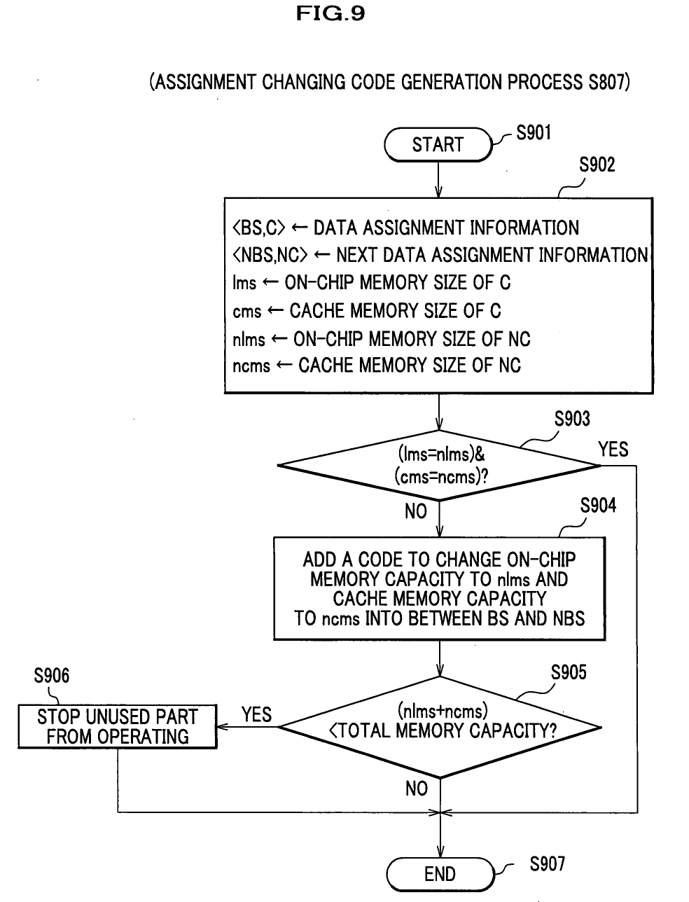

Then, control is passed to step S805, where it is determined whether the variable NP is an empty set. If being an empty set (YES at step S805), because no phase subsequent to the current phase exists, control is passed to step S803, which processes the next data mapping information. If at step S805 the variable NP is not an empty set (NO at step S805), control is passed to step S806, which takes the next phase out of the variable NP and stores it into a variable np, and obtains data mapping information, i.e., a pair of a basic block set and the data mapping combination for referenced data for the np and stores them into variables NBS and NC respectively. Next, control is passed to an assignment changing code generation process S807, which generates an assignment changing code to change the assignment of the cache memory and the on-chip memory. The assignment changing code generation process S807 will be described in detail later with reference to FIG. 9. After the assignment changing code generation process S807 finishes, control is passed to step S805, which moves on to the next phase.

FIG. 9 is a flow chart showing the assignment changing code generation process. The assignment changing code generation process S807 starts at step S901. At step S902 the data assignment information of the current phase to be processed, i.e., a pair of the basic block set and data assignment information are stored in the variables BS and C, and a pair of the basic block set and the data assignment information of the next phase are stored in the variables NBS and NC. Further, the on-chip memory size and the cache memory size required by the variable C are obtained and stored in variables lms and cms respectively. The on-chip memory size and the cache memory size required by the variable NC are obtained and stored in variables nlms and ncms respectively. Then, control is passed to step S903, where it is determined whether the values of the lms and nlms are the same and the values of the cms and ncms are the same. If being the same (YES at step S903), because changing the assignment is not necessary, control is passed to step S907, which ends the process. If not being the same (NO at step S903), control is passed to step S904, which adds a code to change the on-chip memory capacity and the cache memory capacity to the values of the nlms and ncms into between the basic block sets of the variables BS and NBS.

Next, at step S905 it is determined whether the sum of the nlms and ncms is less than the total memory capacity. If less than the total memory capacity (YES at step S905), because it means that the embedded memory region has a part not necessary in the operation of the next phase, control is passed to step S906, which generates a code to stop the unused part from operating. Then, control is passed to step S907, which ends the process. If not less than the total memory capacity (NO at step S905), i.e., no unused part exists, control is passed to step S907, which ends the process. The total amount of data that are mapped on the on-chip memory and used at the same time cannot exceed the total capacity of the embedded memory, while the total amount of data that are mapped on the cache memory is not subject to such restriction because hardware dynamically replaces data as needed.

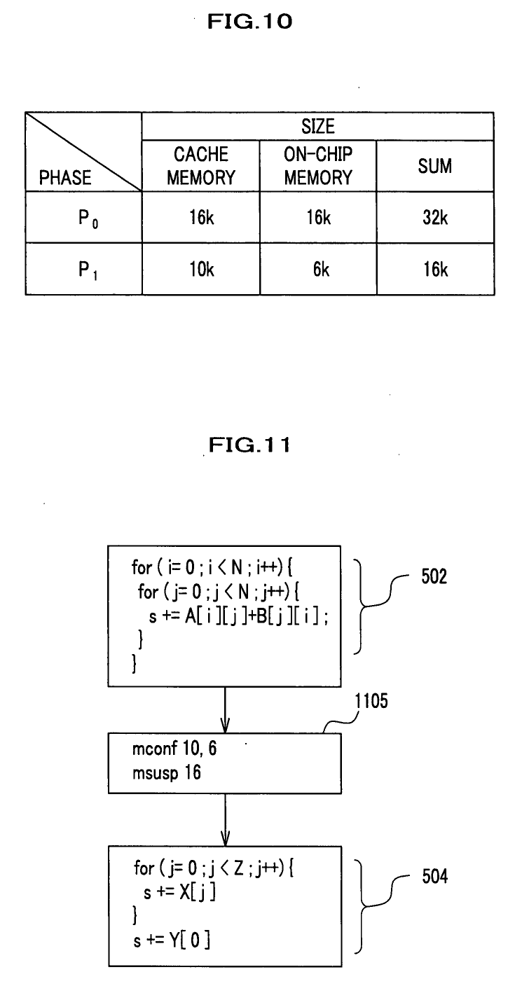

FIG. 10 illustrates an example of data assignment for each phase. It is assumed that by applying the data mapping process S106 of FIG. 6 to the program of FIG. 5A, the data mapping of FIG. 10 is obtained as optimum mapping and that the total memory capacity of the processor concerned that can be assigned to the cache memory and the on-chip memory is 32 Kbytes. Here, phases P₀, P₁ correspond to the loops 502, 504 of FIG. 5A respectively. By applying this result to the code generation process S107 of FIG. 8, at step S802, data assignment information of the loops 502, 504 is stored in the variable M. At step S804, data assignment information of the loop 502 is taken out of the variable M, and information about the loop 504 as the next phase is obtained and stored into the variable NP.

Then, the assignment changing code generation process S807 is called with the loop 502 as the preceding phase and the loop 504 as the subsequent phase to generate an assignment changing code. The process of FIG. 9 results in the lms, cms, nlms, and ncms being at 16 K, 16 K, 10 K, and 6 K, respectively. Because at step S903 the values of the lms and nlms are different, at step S904 a code to change assigned memory capacities is inserted into between the loops 502, 504. Because at step S905 the sum of the nlms and ncms is at 16 K and less than a total memory capacity of 32 K, step S906 generates a code to stop the unused part from operating. This result is shown in FIG. 11.

FIG. 11 illustrates an example of the generated codes. As shown in FIG. 11, a code “mconf 10, 6” to change assignment to the cache memory and the on-chip memory and a code “msusp 16” to stop the unused embedded memory part from operating are inserted in between the loops 502, 504 (1105).

According to the present embodiment, at each boundary of the phases, assignment to the cache memory and the on-chip memory, stopping the unused part from operating, and the like are performed, thus producing effects of making the execution of the program more efficient, reducing power consumption, and the like.

### Embodiment 2

FIG. 12 is a flow chart showing the phase division process for directive statements according to embodiment 2. FIG. 12 shows, for the phase division process S105 of FIG. 1, the process flow of dividing a program into phases by analyzing directives stated in the program instead of analyzing program structures. For simplicity, assume that each directive command forms a basic block by itself. In the example source program of FIG. 5B, command statements 501, 503 means phase specifications. When the process of FIG. 12 is applied to FIG. 5B, sets of the basic blocks forming the loops 502, 504 are recognized as different phases respectively.

As shown in FIG. 12, the phase division process S105A (denoted by the reference numeral S105A different from S105 of FIG. 4 for distinction) starts at step S1201; at step S1202 the basic block sets in the program are obtained and stored into a variable BB; and a variable BS for storing the basic block set forming the current phase in process and a variable P for storing a set of phase information are each initialized to an empty set. Then, at step S1203 it is determined whether the variable BB is an empty set. If being an empty set (YES at step S1203), because no phase to be processed exists, control is passed to step S1208, which adds a pair of the variable BS, i.e., the basic block set forming the current phase in process and a set of the data referenced in the variable BS to the variable P, a phase information set. At S1209 the process is ended.

If at step S1203 the variable BB is not an empty set (NO at step S1203), at step S1204 one element is taken out of the variable BB, i.e., the basic block sets in the order in which the elements emerge in the source code and stored into a variable b.

Next, at step S1205, it is determined whether the variable b is a phase specification. If the variable b is a phase specification (YES at step S1205), control is passed to step S1207, which adds a pair of the variable BS, i.e., the basic block set forming the current phase in process and a set of the data referenced in the variable BS to the variable P, a phase information set, and re-initializes the variable BS for storing the basic block set forming a current phase in process to an empty set. Then, control is passed to step S1203, which starts processing the next basic block. If at step S1205 the variable b is not a phase specification (NO at step S1205), the variable b is added to the variable BS, i.e., the basic block set forming the current phase in process, and control is returned to step S1203, which moves on to the next basic block.

According to the present embodiment, a program can be divided into phases by analyzing directives stated in the program.

### Embodiment 3

Embodiment 3 of the present invention shows, for the data mapping process S106 of FIG. 2, the case where the capacities to be assigned to the cache memory and the on-chip memory in the embedded memory region for each phase are determined according to a directive stated in the source code.

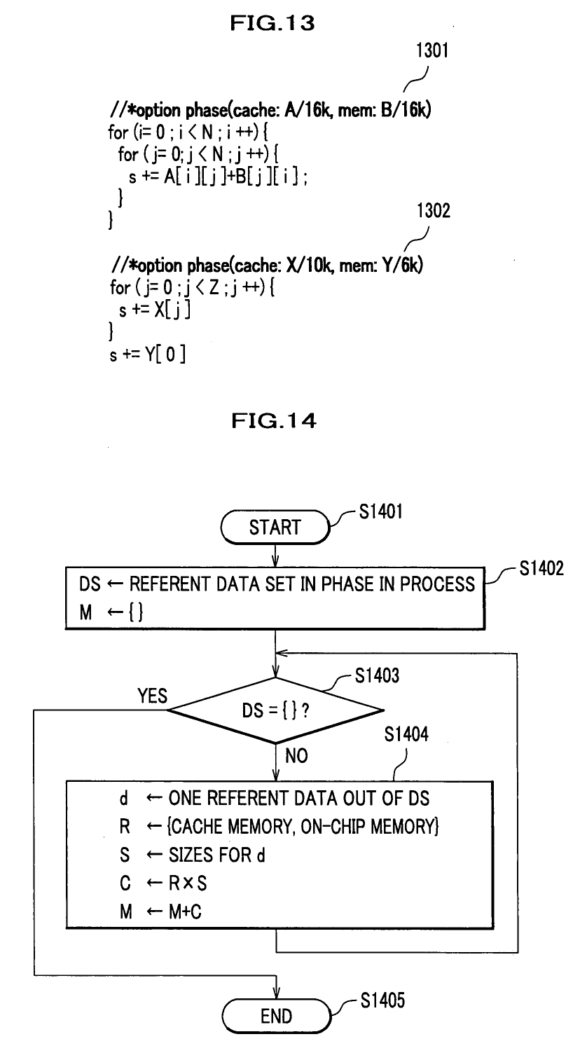

FIG. 13 illustrates an example where directives to specify the capacities to be assigned to the cache memory and the on-chip memory in the embedded memory region for the respective phases are inserted in a source program. As shown in FIG. 13, directives are added to the phase specifications in the program of FIG. 5A to specify the memory to which data used in the phase are assigned and its size. For example, the directive 1301 means to assign 16 Kbytes of cache memory to data A and to assign 16 Kbytes of on-chip memory to data B, and the directive 1302 means to assign 10 Kbytes of cache memory to data X and to assign 6 Kbytes of on-chip memory to data Y. The phase specifications may be read in, e.g., the phase division process S105A of FIG. 12 and used in the data mapping process S106 of FIG. 6.

According to the present embodiment, by determining the capacities to be assigned to the cache memory and the on-chip memory in the embedded memory region according to a directive stated in the source code, fine assignment control becomes possible.

### Embodiment 4

Next, FIG. 14 shows the process flow of determining, for data of variable data size, the effects of the increase and decrease in the data size on the effect of data placement onto the on-chip memory and determining data placement combinations. These combinations are used for the combinations in step S604 of the data mapping process of FIG. 6.

FIG. 14 is a flow chart showing a combination set determining process for data of variable data size according to embodiment 4. First, the process starts at step S1401. At step S1402 a set of the data referenced in the phase in process is obtained and stored in the variable DS, and a variable M for storing a set of data mapping combinations is initialized to an empty set. Then, at step S1403 it is determined whether the variable DS, the set of the data, is an empty set.

If the variable DS is an empty set (YES at step S1403), control is passed to step S1405, which ends the process. Here, the elements in the variable M are data mapping combinations. If at step S1403 the variable DS, the set of the data, is not an empty set (NO at step S1403), control is passed to step S1404, which takes one piece of referenced data out of the variable DS and stores it into a variable d and sets “cache memory” and “on-chip memory” as data-to-be-placed memories in a variable R and stores the sizes which the variable d can take on into a variable S. The combinations of the R and S are stored in a variable C and are the data mapping combinations that the variable d can take. Hence, the combinations are added to the variable M, a set of data mapping combinations. Then, control is passed to step S1403, which moves on to the next data.

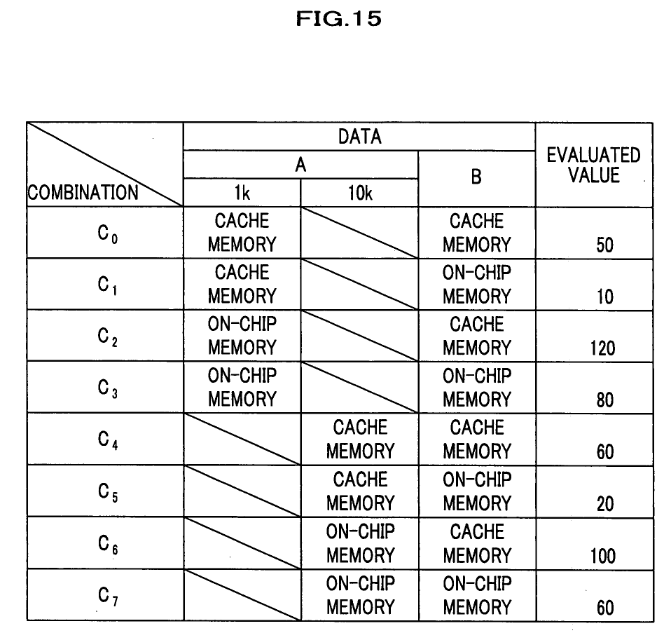

FIG. 15 illustrates the evaluated values of the data mapping combinations for data of variable data size. FIG. 15 shows possible data placements and their evaluated values for data A of variable data size, here 1 Kbytes or 10 Kbytes. Here, it is assumed that for data A of 1 Kbytes, the expected value of performance improvement is 0 and 70 respectively for when placed on the cache memory and when placed on the on-chip memory, that for data A of 10 Kbytes, the expected value is 10 and 50 respectively, and that for data B, the expected value is 50 and 10 respectively. Further, assume that the evaluated value for each data placement is given as the sum of the expected values for the set of the referenced data. From the results, it is found that placing data A of 1 Kbytes on the on-chip memory and data B on the cache memory (C₂) produces the highest effect. By selecting this at step S604 of the data mapping process S106, the optimum effect can be obtained.

According to the present embodiment, by determining, for referenced data of variable data size, a data size for which the evaluated value (evaluation measurement) is optimal when increasing and decreasing the data size and then assigning the data of the determined data size to the cache memory or the on-chip memory, the data in the program can be placed efficiently.

The code generation methods according to the embodiments of the present invention comprise the phase division process S105 that extracts each phase on the basis of a phase per loop in the program and the referent data referenced in each phase and that divides the program; the memory determining process (e.g., the data mapping process S106) that determines the memory capacities to be allocated to the cache memory and the on-chip memory according to the memory sizes required for a set of the referenced data divided in the phase division process; and the code generation process S107 that generates instructions to change the memory capacities allocated to the cache memory and the on-chip memory based on the determined memory capacities, which codes are placed at switching points between phases in the program. According to the code generation methods, for processors that can select values for the individual memory capacities to be assigned to the cache memory and the on-chip memory, code to allow the program to operate efficiently can be generated, thus improving the execution performance of the program.

In the above embodiments, processes are performed for each phase on the basis of a phase per loop in the program, but not being limited to this, instead of each phase, each program may be processed, which process is an embodiment of the present invention.

It is contemplated that numerous modifications may be made to the exemplary embodiments of the invention without departing from the spirit and scope of the embodiments of the present invention as defined in the following claims.

What is claimed is:

1. A code generation method for a program that runs on a microprocessor having a cache memory and an on-chip memory embedded therein with a capability of specifying and assigning embedded memory capacities, the method comprising:
a memory determining process that determines memory capacities to be allocated to the cache memory and the on-chip memory according to memory sizes required for a set of referent data in the program; and
a code generation process that generates a code based on the memory capacities determined in the memory determining process.

2. The code generation method according to claim 1, wherein the code generation process comprises generating an instruction to change the memory capacities allocated to the cache memory and the on-chip memory based on the memory capacities determined in the memory determining process, and placing the instruction at a switching point in the program.

3. The code generation method according to claim 1, wherein the memory determining process comprises obtaining an effect to be achieved when data are placed on the on-chip memory and an effect to be achieved when the data are referenced via the cache memory, and selecting an allocation with which an evaluation measurement of execution performance of the program is most improved.

4. The code generation method according to claim 1, further comprising providing a source code with a directive described therein or with a compiler option specified to perform the memory determining process.

5. The code generation method according to claim 3, wherein the memory determining process comprises obtaining a data size of the set of referent data with which the evaluation measurement is optimal if the set of referent data is of variable data size, and assigning the obtained data size to the capacity of the cache memory or the on-chip memory.

6. The code generation method according to claim 3, wherein the evaluation measurement includes at least one of execution time of the program and power consumption of the microprocessor.

7. The code generation method according to claim 2, wherein the code generation process comprises generating one of first and second instructions if allocation to one of the cache memory and the on-chip memory is unnecessary, wherein the first instruction is an instruction to stop operation of the unnecessary memory, and the second instruction is an instruction to put the unnecessary memory into a low power mode.

8. A code generation method for a program that runs on a microprocessor having a cache memory and an on-chip memory embedded therein with a capability of specifying and assigning embedded memory capacities, the method comprising:
a phase division process that extracts at least one phase each comprised of a loop in the program and a set of referent data referred to in each phase, to divide the program; and
a memory determining process that determines memory capacities to be allocated to the cache memory and the on-chip memory according to the memory sizes required for the set of referent data divided in the phase division process.

9. The code generation method according to claim 8, further comprising:
a code generation process that generates an instruction to change the memory capacities allocated to the cache memory and the on-chip memory based on the memory capacities determined in the memory determining process, and placing the instruction at a switching point between phases in the program.

10. The code generation method according to claim 8, wherein the phase division process comprises dividing the program at a point of low data reference frequency determined by control flow analysis for analyzing operation of the program.

11. The code generation method according to claim 8, further comprising providing a source code with a directive described therein or with a compiler option specified to perform the phase division process.

12. The code generation method according to claim 8, wherein the memory determining process comprises obtaining an effect to be achieved when data are placed on the on-chip memory and an effect to be achieved when the data are referenced via the cache memory, and selecting an allocation with which an evaluation measurement of execution performance of the program is most improved.

13. The code generation method according to claim 8, further comprising providing a source code with a directive described therein or with a compiler option specified to perform the memory determining process.

14. The code generation method according to claim 12, wherein the memory determining process comprises obtaining a data size of the set of referent data with which the evaluation measurement is optimal if the set of referent data is of variable data size, and assigning the obtained data size to the capacity of the cache memory or the on-chip memory.

15. The code generation method according to claim 12, wherein the evaluation measurement includes at least one of execution time of the program and power consumption of the microprocessor.

16. The code generation method according to claim 9, wherein the code generation process comprises generating one of first and second instructions if allocation to one of the cache memory and the on-chip memory is unnecessary, wherein the first instruction is an instruction to stop operation of the unnecessary memory, and the second instruction is an instruction to put the unnecessary memory into a low power mode.

17. A compiler for a program that runs on a microprocessor having a cache memory and an on-chip memory embedded therein with a capability of specifying and assigning embedded memory capacities, the compiler causing a computer, for optimization of the program, to execute:
a phase division process that extracts at least one phase each comprised of a loop in the program and a set of referent data referred to in each phase, to divide the program;
a memory determining process that determines memory capacities to be allocated to the cache memory and the on-chip memory according to the memory sizes required for the set of referent data divided in the phase division process; and
a code generation process that generates an instruction to change the memory capacities allocated to the cache memory and the on-chip memory based on the memory capacities determined in the memory determining process, and placing the instruction at a switching point between phases in the program.

18. The compiler according to claim 17, wherein the phase division process comprises dividing the program at a point of low data reference frequency determined by control flow analysis for analyzing operation of the program.

19. The compiler according to claim 17, wherein the phase division process is implemented with a directive described in a source code or with a compiler option specified.

20. The compiler according to claim 17, wherein the memory determining process comprises obtaining an effect to be achieved when data are placed on the on-chip memory and an effect to be achieved when the data are referenced via the cache memory, and selecting an allocation with which an evaluation measurement of execution performance of the program is most improved.

21. The compiler according to claim 17, wherein the memory determining process is implemented with a directive described in a source code or with a compiler option specified.

22. The compiler according to claim 20, wherein the memory determining process comprises obtaining a data size of the set of referent data with which the evaluation measurement is optimal if the set of referent data is of variable data size, and assigning the obtained data size to the capacity of the cache memory or the on-chip memory.

23. The compiler according to claim 17, wherein the code generation process comprises generating one of first and second instructions if allocation to one of the cache memory and the on-chip memory is unnecessary, wherein the first instruction is an instruction to stop operation of the unnecessary memory, and the second instruction is an instruction to put the unnecessary memory into a low power mode.
